(19) United States
(12) Patent Application Publication
(10) Pub. No.: US 2025/0130872 A1
(43) Pub. Date: Apr. 24, 2025

(54) SYSTEM AND METHOD FOR MANAGING CONCURRENT EVENTS

(71) Applicant: Twilio Inc., San Francisco, CA (US)

(72) Inventors: Evan Cooke, San Francisco, CA (US); Frank Stratton, San Francisco, CA (US); Kyle Conroy, San Francisco, CA (US)

(21) Appl. No.: 19/005,904

(22) Filed: Dec. 30, 2024

Related U.S. Application Data
(63) Continuation of application No. 18/658,473, filed on May 8, 2024.
Application No. 18/658,473 is a continuation of application No. 17/304,703, filed on Jun. 24, 2021, now Pat. No. 12,020,088.
Application No. 17/304,703 is a continuation of application No. 16/580,579, filed on Sep. 24, 2019, now Pat. No. 11,093,305.
Application No. 16/580,579 is a continuation of application No. 15/291,386, filed on Oct. 12, 2016, now Pat. No. 10,467,064.
Application No. 15/291,386 is a continuation of application No. 13/764,594, filed on Feb. 11, 2013, now Pat. No. 9,495,227.
(60) Provisional application No. 61/597,239, filed on Feb. 10, 2012.

(51) Int. Cl. G06F 9/54; G06F 9/50

(52) U.S. Cl. CPC G06F 9/542; G06F 9/5027; G06F 2209/504; Y02D 10/00

(57) ABSTRACT

A system and method that includes receiving an API request to a type of API resource; retrieving an API concurrency value for the API request; determining a comparison status associated with a comparison of the API concurrency value to a concurrency threshold; if the comparison status is within the concurrency threshold, transmitting the API request to an API processing resource; if the comparison status indicates the concurrency threshold is not satisfied, impeding processing of the API request; accounting for an increase in the API concurrency value if the API request is transmitted to an API processing resource; and accounting for a decrease in the API concurrency value at a time associated with the API processing resource completing processing of the API request.

### CROSS-REFERENCE TO RELATED APPLICATIONS

This application is a continuation of U.S. application Ser. No. 18/658,473, filed 8 May 2024, which is a continuation of U.S. application Ser. No. 17/304,703, filed 24 Jun. 2021, which is a continuation of U.S. application Ser. No. 16/580,579, filed 24 Sep. 2019, which is a continuation of U.S. application Ser. No. 15/291,386, filed 12 Oct. 2016, which is a continuation of U.S. application Ser. No. 13/764,594, filed 11 Feb. 2013 which claims the benefit of U.S. Provisional Application Ser. No. 61/597,239, filed on 10 Feb. 2012, all of which are incorporated in their entireties by reference.

### TECHNICAL FIELD

This invention relates generally to the telephony field, and more specifically to a new and useful system and method for managing concurrent events in the telephony field.

### BACKGROUND

In recent years, Innovations in the web application and Voice over Internet Protocol (VOIP) have brought about considerable changes to the capabilities offered through traditional phone services. New services and platforms have been introduced that integrate telephone voice conversations with website interaction, which has required an increase in the amount of data being transmitted between various servers and applications. Likewise, along with the increase in data traffic there is an increase in the data available to system users and developers. Where traditional telecommunications modalities might have made this data available sporadically, only via paper transactions, and/or for additional fees, users and developers in cloud-based communications expect to have access to large data amounts at their fingertips. Unfortunately, certain types of data transmissions have a tendency to crowd out and/or slow down the actual communications pipelines in the system, thus lessening the value of the system and the user/developer experience. In particular, large amounts of concurrent requests from users/developers can impede data traffic and/or communications between servers and applications. Thus, there is a need in the telephony field to create a new and useful system and method for managing concurrent events. This invention provides such a new and useful system and method.

### BRIEF DESCRIPTION OF THE FIGURES

FIG. 1 is a schematic representation of a system of a preferred embodiment;

FIG. 2 is a detailed schematic representation of an alternative embodiment of a system of a preferred embodiment;

FIG. 3 is a communications schematic of a method of a preferred embodiment;

FIG. 4 is a schematic representation of a method for rate limiting requests of a preferred embodiment;

FIG. 5 is an exemplary schematic representation of monitoring and regulating requests by accounts;

FIG. 6 is an exemplary schematic representation of monitoring and regulating requests by API resource type;

FIG. 7 is an exemplary schematic representation of monitoring and regulating requests based on API resource type and account;

FIG. 8 is an exemplary graphic representation comparing types of rate values and rate limits;

FIG. 9 is a communications schematic of a variation of a method of a preferred embodiment that includes processing a reaction for a delay comparison status;

FIG. 10 is a communications schematic of a variation of a method of a preferred embodiment that includes transitioning traffic to a low-priority service resource; and

FIG. 11 is a communications schematic of a variation of a method of a preferred embodiment that includes accounting for an API request timeout.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Managing Concurrent Events

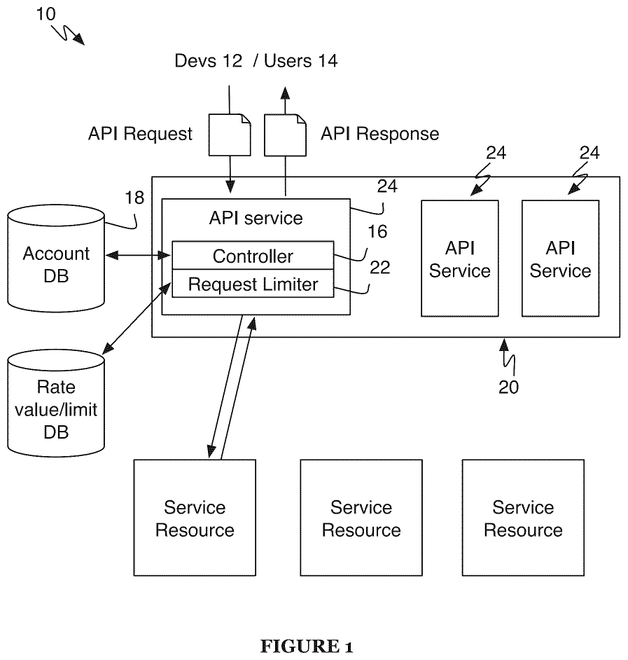

As shown in FIG. 1, a system 10 of the preferred embodiment can include a controller 16, an account database 18, and an application programming interface (API) cluster 20. The preferred system 10 can further accommodate developers 12 and users 14, all of whom can interact though the API cluster 20 in performing one or more tasks or functions within a cloud-based telephony platform of the type described in issued U.S. Pat. No. 8,306,021, application Ser. No. 12/417,630, filed on 2 Apr. 2009, and entitled “System and Method for Processing Telephony Sessions,” which is incorporated herein in its entirety by this reference. The system 10 preferably functions to monitor, partition, allocate, distribute, and/or manage the use of dedicated API resources within the API cluster 20 in order to ensure an efficient and desirable experience for developers 12 and users 14. The system may be particularly configured to monitor and regulate API resource requests based on the account associated with the request and/or based on the resource type/categorization. In such configuration, the system may function to prevent excessive requests of one account from aversely impacting the requests of another account, and similarly the system may additionally or alternatively function to prevent requests to one resource type from adversely impacting requests to another resource type. The system is preferably implemented for request concurrency monitoring and regulation, but the system may alternatively be employed for other suitable request rate monitoring or regulation such as request initiation rate (e.g., requests per second/minute/hour/day), conclusion rate, simultaneous/bulk request rate, or any suitable rate. Preferably, the system 10 performs these functions in real time or near real time such that API resources are optimized by the demands requested of each user account.

As shown in FIG. 1, the preferred system 10 can include a controller 16 connected to the account database 18 and the API cluster 20. The controller 16 preferably functions to manage all interactions between the account database 18 and the API cluster 20. Preferably, the controller 16 can organize, sort, maintain, gather, and/or distribute data records for accounts holders in the account database 18 including any concurrency limits associated with an account. Preferably, each account includes a rate limit (e.g., a concurrency limit), which can be individualized or customized for each account based upon user request, user history, user demand, or any other suitable metric. Alternatively, each account can include a default rate limit established upon entry into the system 10, wherein the default rate limit can be altered or adjusted based on any suitable metric noted above. Alternatively, the rate values and/or rate limits may be stored in alternative databases or stored in any suitable manner. In one variation, there is a rate value database and a rate limit database. The rate value may store calculated values, which can be updated at anytime. Alternatively, the rate value database may be used for tracking API requests. For example, the rate value database or any suitable database may store a log of requests. When used to measure concurrency, a record is preferably created to account for the initiation of the processing of the request (e.g., when the request is delivered to a service resource). Additionally, the record is preferably removed or marked as ended when the request has completed (e.g., after a service resource has finished processing or after/when an API response is sent).

In a preferred mode of operation, each account makes a request (e.g., an http request) in using the system 10. The requests can be time stamped, cataloged, categorized, and/or otherwise captured by the request limiter 22 as described below. Preferably, each actual request made by each account is tracked by an API service 24, the request limiter 22 and/or the controller 16 in order to ascertain the API resource allocation on a per account basis for any suitable time period, including instantaneous or substantially instantaneous snapshots of the resource consumption in the API cluster 20. Alternatively or additionally, each account can have a maximum rate value as well as a current rate value recorded and stored at predetermined intervals such that during each interval, the greatest concurrent users of the API resources can be determined and managed. Preferably, the current rate value is compared with the maximum rate value for each account during the predetermined interval, i.e., in a two-entry dataset including a current value and a max value. Alternatively, the request limiter 22 can be configured to keep a running of an explicit count of requests for each user, which can either be maintained indefinitely or reset at predetermined intervals as described herein. In response to an account exceeding its rate value in the predetermined value, the preferred request limiter 22 adjusts or alters the API resources dedicated to the user account as described below. The preferred predetermined interval can include any suitable interval, either static or dynamic in nature. In one example configuration of the system 10, the predetermined interval is approximately six seconds, such that the monitoring of API resource requests and/or usage is substantially instantaneous and historical resource usage by a user account does not prejudice its current resource allocation.

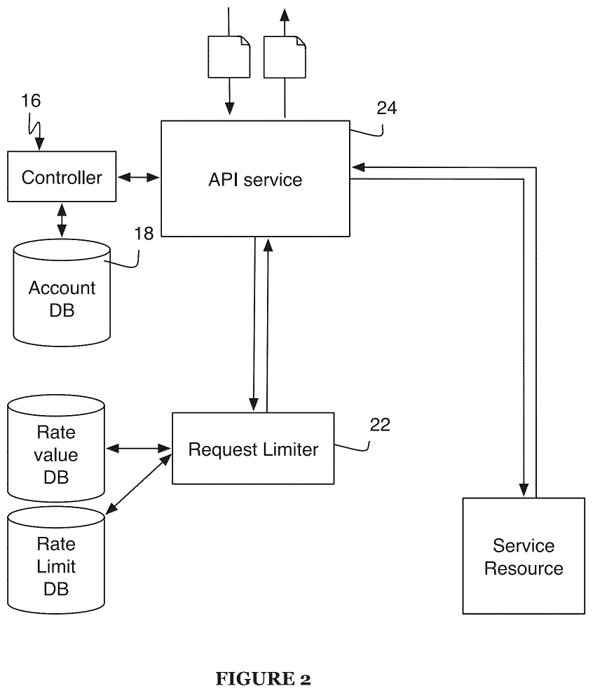

As shown in FIG. 1, the API cluster 20 can include a plurality of API services 24 connected and/or operatively coupled to the request limiter 22. Preferably, the each API service 24 can include its own request limiter 22 service located and/or operating locally on the respective API service 24. Alternatively, a single request limiter 22 or distinct request limiter 22 can function to serve a group or plurality of API services 24 within the API cluster 20 as shown in FIG. 2. An API service 24 may be configured for performing a series of processes that may include receiving a request, determining if the account has permissions to perform the request, checking the rate value against a rate limit, optionally transmitting the request to an appropriate service resource, responding to the request and/or any other suitable process. Preferably, the request limiter 22 functions with each API service 24 to monitor and/or adjust the consumption of API resources by large accounts. In a telephony platform of the type incorporated by reference above, only certain types of requests of the servers will take a substantial amount of time and thus impact the relative usage of concurrent API resources. For example, if a user makes a request for call records or other large data sets, the API service 24 must dedicate a significant amount of resources to handle the data traffic. As such, the preferred request limiter 22 can be configured to alert the API service 24 to any burdensome usage so that the API service 24 can transition traffic of the high-usage accounts into less crowded (and perhaps slower) data channels, as the resources allocated to those accounts is both data intensive and not particularly time sensitive as compared to the normal operations of the telephony platform. Additionally or alternatively, in response to excessive concurrent usage of the API by an account, the request limiter 22 and/or API service 24 can be further configured to transmit an error message to the account, slow down requests from the account to the API, and/or send other notifications and/or alerts to the account to inform the user of the excess and any action that the user might take to remedy its consumption.

### 2. Method for Managing Concurrent Events

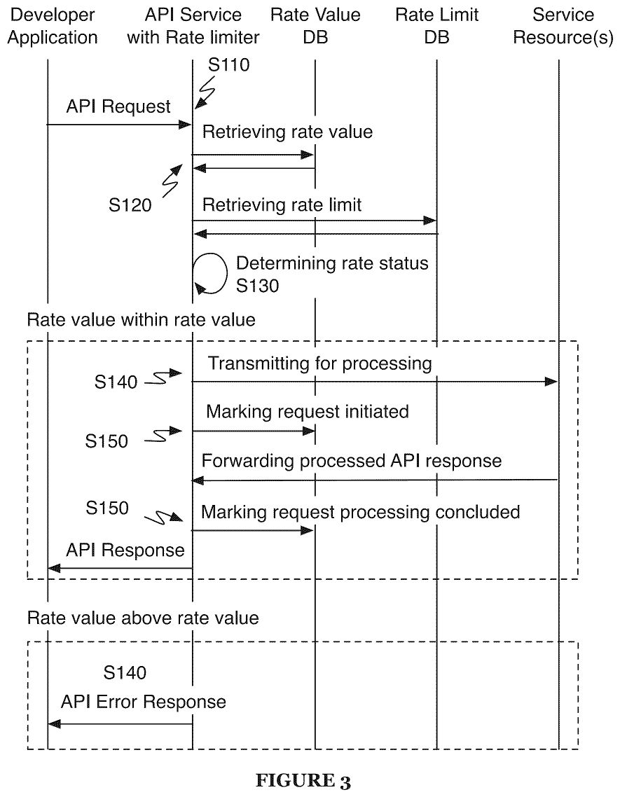

As shown in FIG. 3, a method of a preferred embodiment can include receiving API request S110, retrieving an API rate value S120, determining a comparison status associated with a comparison of the API concurrency value to a concurrency limit S130, processing a reaction to the API request according to the comparison status S140, and accounting for changes in the API usage rate S150. The method functions to monitor, partition, allocate, distribute, and/or manage the use of dedicated API resources and services. More preferably, the method functions to facilitate a multitenant ecosystem of a telephony platform such as the one incorporated by reference above. Preferably, the method performs these functions in real time or near real time such that API resources are monitored and regulated for each user account. As a first exemplary application of a method of a preferred embodiment, the method may be applied to balance the use of API resources between accounts. As a second exemplary application of a method of a preferred embodiment, the method may be applied to balance the use of specific API resources, such that one type of API request may be rate limited different from a second type of API request. For example, API REST requests directed at a “/SMS/Messages” resource type may be rate limited independently from API REST requests directed at a “/Calls” resource type. The method is preferably used in rate limiting based on request concurrency-requests that are actively serviced, processed, handled and/or in progress. Aligning the API request rate with API concurrency rate preferably accounts for variable, extended, or otherwise challenging API request latency issues. Herein, the method may be described as being applied to API concurrency rates, but the method may alternatively or additionally be used in rate limiting based on request initiation rate (e.g., requests per second/minute/hour/day), conclusion rate, simultaneous/bulk request rate, or any suitable activity rate.

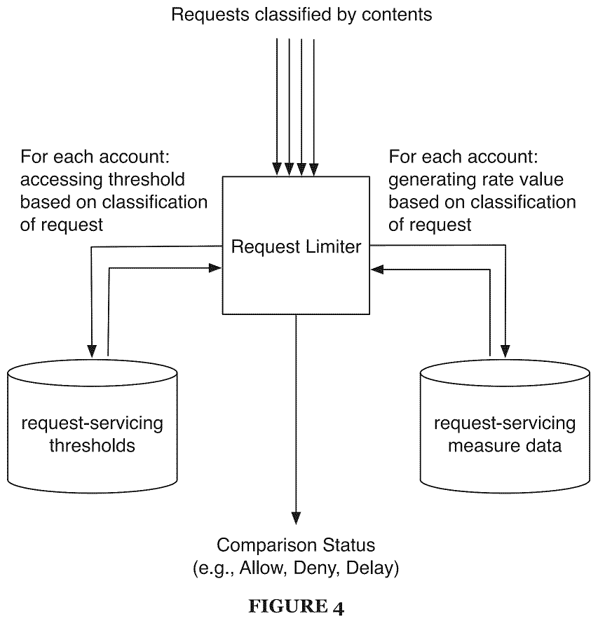

Step S110, which includes receiving an API request, functions to receive account activity relating to API resource usage. Receiving an API request preferably includes recording, recognizing, and/or receiving activity associated with each account (e.g., user or developer) associated with the telephony platform. The API request is preferably received at an API service or server. API requests initiated by a user account, application or other source are preferably routed through the API platform to the API service. A plurality of API services or servers preferably work in parallel and/or in cooperation to service a plurality of requests. Each API request is preferably processed by a request limiter and then, based on the results of the rate monitoring process, the API request can be processed by appropriate services, rejected, delayed or handled in any suitable manner as shown in FIG. 4. Example account activity can include requests (such as http requests, data requests, session requests, application requests and the like) made by a user account of the API. Preferably, account activity can include at least any type of account action or request that utilizes API resources within the telephony platform. Preferably, account activity can include a number of requests made relative to a maximum number of requests available to the account. The maximum request value can be customized for each account or set to a default value or any suitable combination thereof. As noted above, preferably each account can have a maximum concurrency value as well as a current concurrency value recorded and stored at predetermined intervals such that during each interval, the greatest concurrent users of the API resources can be determined and managed. The API request is preferably composed of content that may include headers, authentication section, and/or a body. The various parts of the request contents may specify IP addresses, authentication parameters, URI's, API instructions, data, parameters, and/or any suitable content type. The contents of the API request are preferably inspected and at least a sub-set of the contents may be used to classify the API request. The classification of an API request may be used in retrieving/generating rate values and limits associated with API requests of that type or classification. For example, API requests are preferably classified by the account making the request. The authentication parameters (e.g., an account secure identifier and an auth token) may be used to uniquely determine rate values and/or rate limits. As described herein the requests may alternatively be classified by the request/resource type, combinations of request content parameters, or any suitable aspect.

In one implementation of a preferred embodiment, the API service routes the API request to a request limiter. Alternatively, operation of the request limiter may be integrated into the API request processing of an API server or service. As noted above, a preferred configuration of the system can include multiple API services each served by a single request limiter. Alternatively, each API service can have its own local request limiter, in which case sending a request from the API to the request limiter can include a local intra-API request, notification or process flow.

The API requests preferably specify an API resource. The API resource preferably relates to an API resource type, category, class, or sub-class. API requests of a similar API resource type can have similar patterns in platform resource usage, latency, and other processing factors. The API requests additionally specify or are uniquely associated with an account and/or sub-account. Preferably, the API request can include an account number, name, or identifier of the account (or sub-account) seeking the API resources. The request can include any other suitable identifying information such as a time stamp of the account request(s) for more precisely identifying each individual request of each account. The preferred request of block S102 can include any other suitable information (API identification and available API resources, for example) usable by a request limiter in performing its functions.

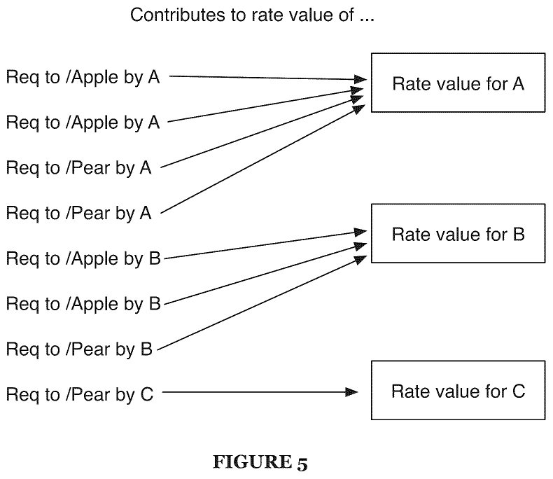

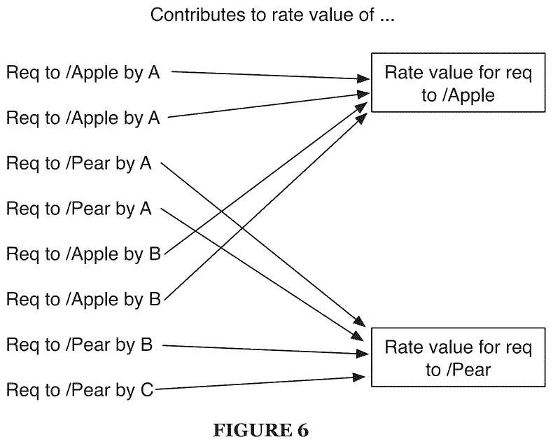

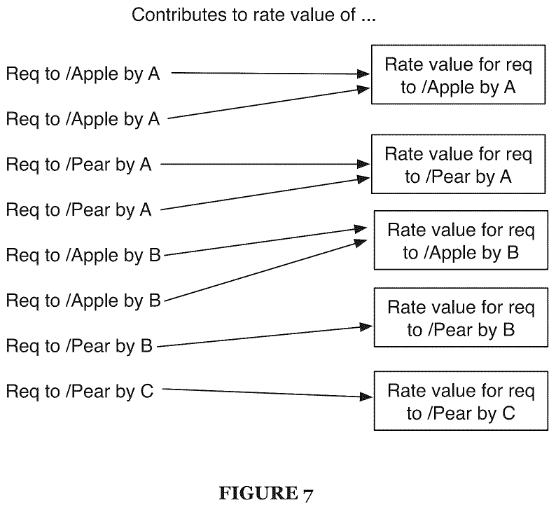

Step S120, which includes retrieving an API rate value, functions to compare, calculate, compute, access, generate, and/or check a rate value. The rate value may function as a request-servicing measure of the current status/state of processing requests. The API rate value is preferably a concurrency value, but may alternatively be any suitable rate value. In a first variation, the concurrency value is preferably a concurrency value for the account associated with the API request. As shown in FIG. 5, requests may then be segmented, monitored and regulated based on the accounts to which the requests belong. Similarly, the concurrency value may be for sub-account, for specific endpoints of an account or sub-account (e.g., phone number, short code, SIP address, and the like), or request properties (e.g., location, carrier, modality, etc). In another variation, the concurrency value can be a concurrency value for API requests of a particular API resource type or category. As shown in FIG. 6, requests may be segmented, monitored, and regulated based on the resource type, categorization, or request parameters. The API rate value may alternatively be assigned to a specific account for a particular API resource type or category. As shown in FIG. 7, requests may be segmented, monitored and regulated based on resource type and associated account. For example, an account rate is preferably maintained independently for API requests to “/Calls” resources made by Account A, to “/SMS/Messages” resources made by Account A, and to “/Calls” resources made by Account B. Alternatively, the concurrency value may be global or multi-account rate value. The rate value may have any suitable resolution and segmentation for request monitoring. The rate value may additionally or alternatively relate/reflect a request initiation rate (e.g., requests per second/minute/hour/day), conclusion rate, simultaneous/bulk request rate, or any suitable rate.

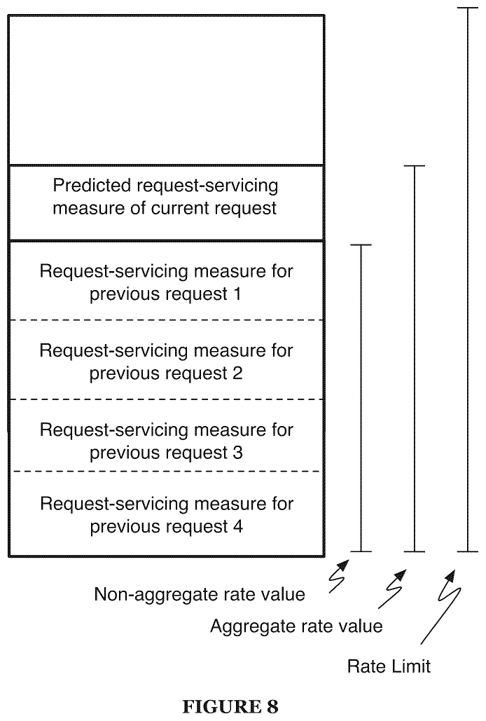

The rate value is preferably accessed or calculated from records stored in a rate database (or databases). The rate value is preferably stored, maintained, and identified in the database by key values relating to the granularity/resolution of rate monitoring (e.g., globally, per account, per resource, per account usage of a resource, etc.), Preferably, the contents of a request are used in accessing values or data from which a rate value can be or has been calculated. The contents of a request preferably include a header, an authentication portion, and a body. The contents can preferably specify IP addresses, authentication parameters such as account secure identifiers and auth tokens (which can be used to identify accounts), data, URI's indicating targeted API resources, and/or any suitable data. In one variation, parameters from the contents of the request are used to access request-processing data/measurements in a database, and a rate value calculated. For example, after inspecting and identifying account information for who is making the request, the a concurrency value that o indicated the number of active requests currently being processed can be obtained from a database by querying data for that account. A database may store a plurality of request history records from which a rate value is calculated. The request history preferably tracks the requests that are being processed but have not completed (i.e., actively processed requests). Preferably, the concurrency value computation can include either computing an absolute concurrency value, such as a number of account requests, or a relative concurrency value measuring a difference between a current value and a maximum value. The rate value may alternatively be stored or pre-calculated. Alternatively, retrieving a rate value can include calculating a rate value. Additionally, the rate value may be based on a request-servicing measure of previous requests. In other words, the rate value may reflect the value as it is before allowing the request to be processed. Alternatively, the rate value may be an aggregate value. In an aggregate value, the predicted/expected request-servicing measure (e.g., cost) that would be contributed by the single API request is added to the request-servicing measure of at least a sub-set of previous requests as shown in FIG. 8. The sub-set of previous requests preferably includes requests currently being processed, but may alternatively include requests in a time window or selected in any suitable manner.

An alternative or additional aspect of retrieving an API rate value, the rate value may be based at least in part on the available resources used to process requests. For example, the servers, the capacity of the media processors, data storage resources, and other resources used to service the API requests may impact the rate value (and/or optionally the rate limit). Such resources may additionally be measured based on classification of the API request. For example, the resources used to process one type of API request may be measured differently from resources dedicated to processing a second type of API.

Step S130, which includes determining a comparison status associated with a comparison of the API rate value to a rate limit, functions to compare the retrieved rate value to a threshold during a predetermined interval or window. Preferably, the rate value and the rate limit are maintained with the same association/granularity. That is to say, if the rate value is maintained for each account, the rate limit is similarly assigned for each account. The rate limit may alternatively be a default value, based on the resource type or classification, based on the account, or assigned in any suitable manner. The rate limit may additionally be dynamic. For example, the rate limit may adjust based on the current (e.g., real-time), recent, and/or past API usage. In another exemplary scenario, the rate limit may adjust based on the capacity of the API service resources. For example, if a cluster of services goes down, then the rate limit preferably is lowered to account for the change in processing capacity. In one preferred embodiment, the rate value and the rate limit are stored in a two-entry dataset. Alternatively, the request limiter can maintain a running and explicit count of requests for each user, which can either be maintained indefinitely or reset at predetermined intervals as described herein. As noted above, a suitable interval can be on the order of approximately six seconds, although any other interval or range of intervals is equally applicable to the preferred method.

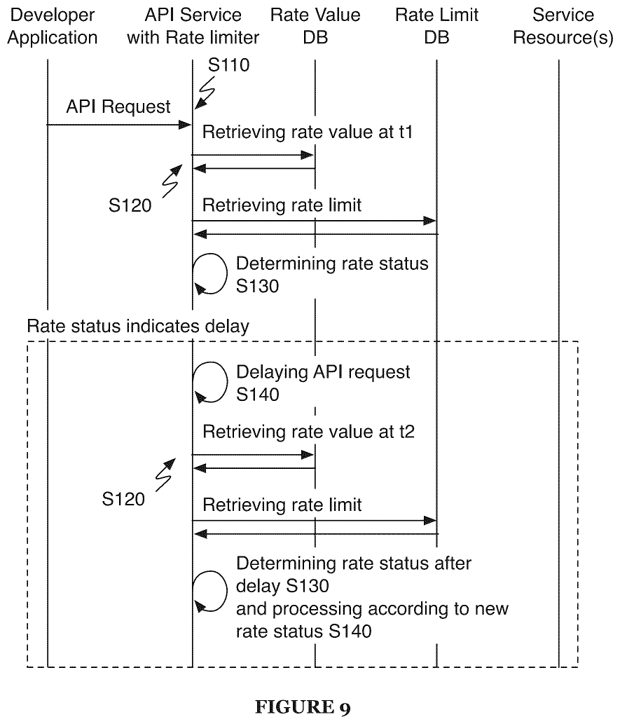

The comparison status preferably corresponds to defined conditions and corresponding actions. The magnitude of the rate value is preferably compared to a rate limit, and the condition is based on the sign and/or magnitude of the relative values. In one variation, the comparison status is decided by determining whether the account has and/or is exceeding a concurrency limit. In one preferred embodiment, possible comparison statuses preferably include proceed, cancel, and/or delay conditions. The proceed comparison status preferably indicates that the API usage is within the limits and that the API request should be serviced normally. The cancel comparison status preferably indicates that the API usage is in violation of the API usage (e.g., rate value exceeds the rate limit, too many concurrent API requests, or too many requests made within a time window). API requests that receive a cancel status will preferably be dropped, canceled, sent an error message, or fail in any suitable manner. The delay comparison status preferably indicates that the API request can be processed at a later time. The delay comparison status may be used in addition or as an alternative to the cancel comparison status. The API request with a delay comparison status may be queued, added to a wait list, scheduled for subsequent processing, or managed in any suitable way such that the API request is not processed immediately. A delayed API request may be subsequently processed by the request limiter as shown in FIG. 9 (such that it may be delayed a plurality of times) or processed by an API service. A plurality of rate values and rate limits may additionally be used in determining a comparison status. For example, the rate values and various rate limits for different segments/granularity of API resource usage could be used for more complex conditional cases. For example, a comparison status may be dependent on the relative values of an account resource rate value, the account resource rate limit, the rate value for the whole system, and a global rate limit.

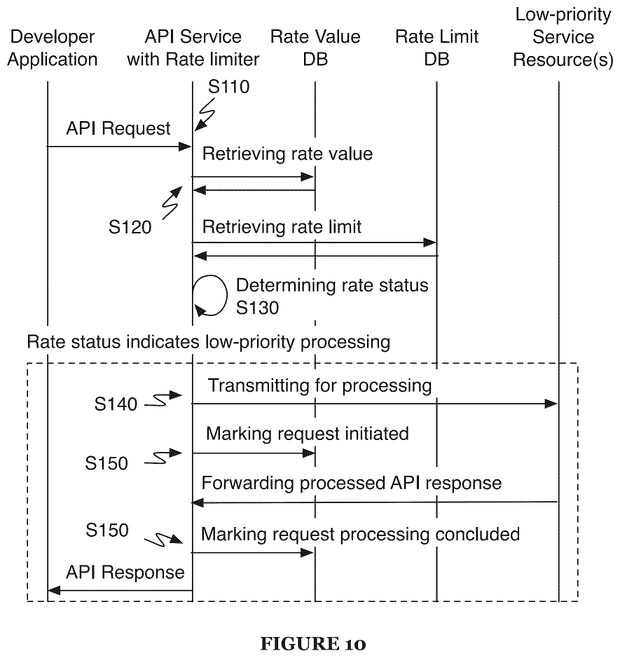

Step S140, which includes processing a reaction to the API request according to the comparison status, functions to treat the API activity according to the comparison status. Processing a reaction preferably includes transmitting the API request to an API processing resource if the comparison is within the rate limit (i.e., a proceed comparison status). In other words, an API request is preferably processed normally if the activity is within normal operation limits. The API processing resource is preferably a service for processing the API request. The API processing resource may additionally or alternatively include a plurality of components. The API processing resource may be a server, a database, a media processor, and/or any suitable resource used in processing an API request. The API processing resources used by a given APi request may be determined by the API resource, API method call, or other content of the API request. Processing a reaction can additionally include impeding processing of the API request if the comparison indicates the concurrency limit is not satisfied. Impeding processing may include, dropping the request, throwing an error message (and replying to API request with an error response), sending a notification, charging or billing at a different rate for the API request over the limit, deprioritizing the API request, processing the API request differently, delaying the API request or processing, or impeding the API request processing in any suitable manner. In one variation of the preferred method, impeding API request processing can include transitioning traffic of the high-usage accounts to low-priority service resources as shown in FIG. 10. The resources allocated to those accounts may be both data intensive and not particularly time sensitive as compared to the normal operations of the telephony platform. The low-priority service resources are preferably less crowded (and perhaps slower) data channels, but may be resources specialized for a particular task, resources with better or worse performance, or any suitable type of alternative processing resource. Additionally or alternatively, in response to excessive concurrent usage of the API by an account, impeding processing may include transmitting an error message to the account, slowing down requests from the account to the API, and/or sending other notifications and/or alerts to the account to inform the user of the excess and any action that the user might take to remedy its consumption. Processing a reaction can additionally or alternatively include delaying the API request if the comparison is a delay status. In some variations, an API request may be delayed as a form of impeding an API request. If an individual API request has been delayed over a set number of times, the API request may be delivered an error response or otherwise be dropped.

Step S150, which includes accounting for changes in the API usage rate, functions to measure, track, and record the API usage so that the API values are maintained. As mentioned above, the API usage is preferably accounted for based on accounts and/or API resource type, but may additionally or alternatively be tracked based on sub-accounts, endpoints, request properties, and/or any suitable parameter for tracking. In the variation where the method is applied to concurrency rate monitoring and regulating, the initiation and conclusion of API requests are accounted for such that a request limiter has access to information specifying the number of current/active API requests. Accounting for changes in the API usage rate are preferably triggered based on a conditional state. The conditional state is preferably based at least in part on the comparison status. Accounting for changes in the API usage rate preferably includes accounting for an increase in the API concurrency value if an API request is transmitted to a service for processing. In other words, when a service resource processing an API request or when the API request has been sent for processing, a record is generated to account for the in progress nature of the API request. In one variation, the request is logged with a start time, the account information, the API resource(s), and/or any suitable information that may facilitate tracking the API request. Accounting for changes in the API usage rate can additionally include accounting for a decrease in the API concurrency value when an API request is substantially completed. In one variation, the resource servicing the request will forward response data to the API service. The API service will preferably prompt or initiate accounting for the conclusion of that API request, and the API service will transmit an API response with the requested data or information. In a variation, where the rate value is API initiation rate, only the number of API requests made within a set time window may be tracked. The rate value may alternatively be tracked in any suitable manner. Additional conditions may additionally or alternatively be used in combination or separately from the comparison status conditions described above. For example, the condition may only be triggered for a random sampling of API requests or if the number of API requests is above a threshold or if the capacity of the API servicing infrastructure is within a particular threshold.

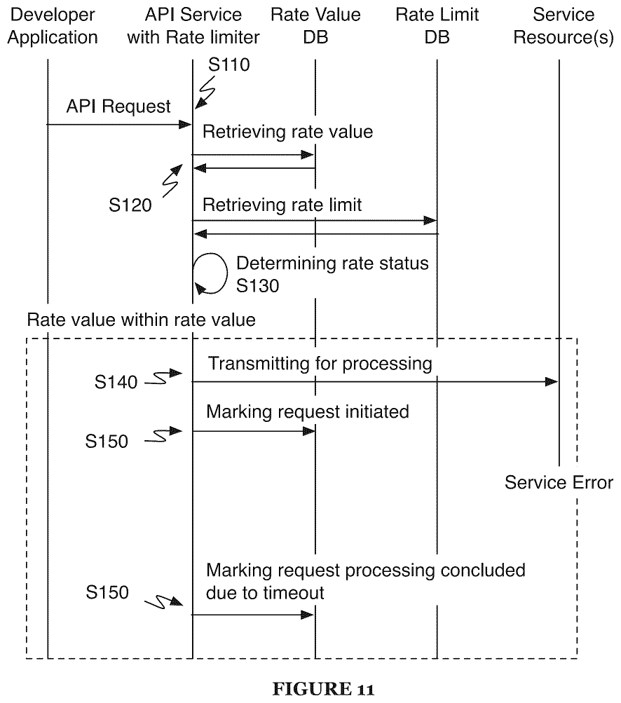

Additionally, accounting for the termination of an API request may occur after a designated timeout. An API server and/or a service resource may fail resulting in an API request to have been initiated but never terminated. The request limiter preferably accounts for a predicted API request processing error by marking a record of the request as concluded, as shown in FIG. 11. The timeout preferably enables tracked API requests to be marked as terminated instead of, for example, remaining as a currently processing API request indefinitely. Preferably, the timeout interval can be any suitable length and can be related to the duration of the predetermined interval described above. More preferably, the time out interval is approximately the same duration as the predetermined interval described above, such that the concurrency values for each account being examined are being reset at approximately the same time as the request limiter is abandoning attempts to transmit any prior and outdated concurrence values to the API. Alternatively, the timeout interval duration can be any other suitable value, whether related or unrelated to any other timing mechanism described herein. Accordingly, each and every block in the preferred method can be performed in parallel by any suitable number of API services interacting with one or more request limiters.

As described above, a method of a preferred embodiment may be applied to a multitenant platform. In such an implementation, at least two accounts make a plurality of API requests. Each API request preferably has the comparison status checked, is processed according the comparison status, and the API request is tracked and monitored. In the variation where the rate value and/or rate limit is based on API concurrency of an account, an API request made by a first account preferably has a comparison status based on the API concurrency of that first account, and an API request made by a second account preferably has a comparison status based on the API concurrency of the second account. Multitenant API usage may additionally be segmented and monitored based on API resource type as described above. In the variation where the rate value and/or rate limit is based on API resource type concurrency of an accounts, an API request made by a first account preferably has a comparison status based on a concurrency value that indicates usage of the first API resource type by the first account, and an API request made by a second account preferably has a comparison status based on a concurrency value that indicates usage of the second API resource type by the second account.

In a preferred embodiment, the method is applied to a multitenant telecommunications API platform. A multitenant platform is preferably characterized by multiple entities (typically embodied through accounts or sub-accounts) accessing and using a service where the resources to support such usage is shared between the entities. The API requests are preferably rate monitored and regulated based on concurrency values and limits. The API requests can additionally be rate monitored and regulated based on account and API resource type. In one exemplary implementation, API requests to API resources for sending messages (e.g., SMS, MMS, or application messages), making outbound voice or video calls (e.g., PSTN, SIP, or video), accessing voice transcripts, accessing message transcripts, accessing video or audio recordings, accessing account information, altering in-session voice or video calls, and/or purchasing or provisioning endpoints (e.g., phone numbers, short codes, SIP addresses etc.) are individually tracked per account. The API resource types may alternatively be monitored in any suitable grouping or categorization of the above mentioned and/or alternative API resources.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the controller 16, the account database 18, the API cluster 20, any one or more API service 24, and/or the request limiter 22. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the various system components and various method processes.

As a person skilled in the art will recognize from the previous detailed description and from the figures and claims, modifications and changes can be made to the preferred embodiments of the invention without departing from the scope of this invention defined in the following claims.

What is claimed is:

1. A system comprising:
one or more computer processors;
one or more computer memories;
a set of instructions stored in the one or more computer memories, the set of instructions configuring the one or more computer processors to perform operations, the operations comprising:
receiving, by an application programming interface (API) service, an API request associated with an account, the API request specifying an API resource type;
retrieving an API rate value for the account; and
granularizing, monitoring, or regulating the API request based on the API resource type and the account.

2. The system of claim 1, wherein the API rate value functions as a request servicing measure of a current state of processing of one or more additional API requests associated with the account.

3. The system of claim 1, wherein the API rate value is a concurrency value for the account.

4. The system of claim 3, wherein the API rate value includes one or more concurrency values for one or more sub-accounts of the account.

5. The system of claim 3, wherein the concurrency value is for additional API requests of an API resource type or category.

6. The system of claim 1, wherein the API rate value reflects a request initiation or conclusion rate.

7. The system of claim 6, wherein the API rate value reflects a bulk request rate.

8. A method comprising:
receiving, by an application programming interface (API) service, an API request associated with an account, the API request specifying an API resource type;
retrieving an API rate value for the account; and
granularizing, monitoring, or regulating the API request based on the API resource type and the account.

9. The method of claim 8, wherein the API rate value functions as a request servicing measure of a current state of processing of one or more additional API requests associated with the account.

10. The method of claim 8, wherein the API rate value is a concurrency value for the account.

11. The method of claim 10, wherein the API rate value includes one or more concurrency values for one or more sub-accounts of the account.

12. The method of claim 10, wherein the concurrency value is for additional API requests of an API resource type or category.

13. The method of claim 8, wherein the API rate value reflects a request initiation or conclusion rate.

14. The method of claim 13, wherein the API rate value reflects a bulk request rate.

15. A non-transitory computer-readable storage medium comprising a set of instructions that, when executed by one or more computer processors, causes the one or more computer processors to perform operations, the operations comprising:
receiving, by an application programming interface (API) service, an API request associated with an account, the API request specifying an API resource type;
retrieving an API rate value for the account; and
granularizing, monitoring, or regulating the API request based on the API resource type and the account.

16. The non-transitory computer-readable storage medium of claim 15, wherein the API rate value functions as a request servicing measure of a current state of processing of one or more additional API requests associated with the account.

17. The non-transitory computer-readable storage medium of claim 15, wherein the API rate value is a concurrency value for the account.

18. The non-transitory computer-readable storage medium of claim 17, wherein the API rate value includes one or more concurrency values for one or more sub-accounts of the account.

19. The non-transitory computer-readable storage medium of claim 17, wherein the concurrency value is for additional API requests of an API resource type or category.

20. The non-transitory computer-readable storage medium of claim 15, wherein the API rate value reflects a request initiation or conclusion rate.
